(19) United States
(12) Patent Application Publication
(10) Pub. No.: US 2025/0039741 A1
(43) Pub. Date: Jan. 30, 2025

(54) GATEWAY AGNOSTIC LOAD BALANCING

(71) Applicant: Cisco Technology, Inc., San Jose, CA (US)

(72) Inventors: Ryan Holland, Pacifica, CA (US); Fiona HALL-ZAZUETA, San Jose, CA (US); Aaron SELESI, Simi Valley, CA (US); Jason Trung Hoa TANG, San Jose, CA (US)

(21) Appl. No.: 18/227,644

(22) Filed: Jul. 28, 2023

(51) Int. Cl. H04W 28/08; H04L 47/125

(52) U.S. Cl. CPC H04W 28/08; H04L 47/125

(57) ABSTRACT

Gateway agnostic load balancing techniques in a network are disclosed. In one embodiment, a process discovers a plurality of remote access enabled gateways with access to a specific subtended device in a computer network. The process determines connective functionality of the plurality of remote access enabled gateways to the specific subtended device and a level of utilization of the plurality of remote access enabled gateways. The process selects a specific gateway of the plurality of remote access enabled gateways through which to open an access session to the specific subtended device based on the specific gateway having sufficient connective functionality and further based on the level of utilization of the plurality of remote access enabled gateways.

### TECHNICAL FIELD

The present disclosure relates generally to computer networks, and, more particularly, to gateway agnostic load balancing, such as for Internet of Things remote access.

### BACKGROUND

The Internet of Things, or “IoT” for short, represents an evolution of computer networks that seeks to connect many everyday objects to the Internet. Notably, there has been a recent proliferation of ‘smart’ devices that are Internet-capable such as thermostats, lighting, televisions, cameras, and the like. In many implementations, these devices may also communicate with one another, such as an IoT motion sensor communicating with a smart lightbulb, to turn the lights on when a person enters a room. The IoT has also expanded to industrial settings as part of the so-called “Industrial IoT” (IIoT) to control manufacturing processes and other operations in industrial settings (e.g., factories, mines, oil rigs, etc.).

As more IoT and IIOT devices are deployed, the number of external users and services that require access to them has also increased. For instance, a remote technician may wish to connect to a particular IoT/IIoT device so that they can perform maintenance on it (e.g., updating its firmware, running diagnostics, etc.). However, the very nature of the IoT/IIoT presents unique challenges that make traditional remote access approaches largely unsuitable.

Some approaches rely on various software solutions to provide secure remote access to IoT assets and devices. Notably, these devices must be accessible via network gateways in order to facilitate communication. Each mechanism for connecting to a device (such as SSH, RDP, VNC, etc.) can be referred to as an access method. Unfortunately, many remote access technologies provide limited options for configuring which gateway an access method should connect through. In most cases, the gateway is statically assigned during initial configuration.

Specifically, IoT technologies need better load balancing to improve efficiency and reliability, but load balancing has never before been applied to gateways managing IoT remote access. In particular, standard load balancing approaches do not account for varied gateway functionality, rendering pre-configuration of load balancing groups an infeasible or impossible task.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example self learning network (SLN) infrastructure;

FIG. 4 illustrates a system for gateway agnostic load balancing in a network; and

FIG. 5 illustrates an example simplified procedure for gateway agnostic load balancing in a network.

### DESCRIPTION OF EXAMPLE EMBODIMENTS

### Overview

According to one or more embodiments of the disclosure, a process discovers a plurality of remote access enabled gateways with access to a specific subtended device in a computer network. The process also determines connective functionality of the plurality of remote access enabled gateways to the specific subtended device and a level of utilization of the plurality of remote access enabled gateways. The process may then select a specific gateway of the plurality of remote access enabled gateways through which to open an access session to the specific subtended device based on the specific gateway having sufficient connective functionality and further based on the level of utilization of the plurality of remote access enabled gateways.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

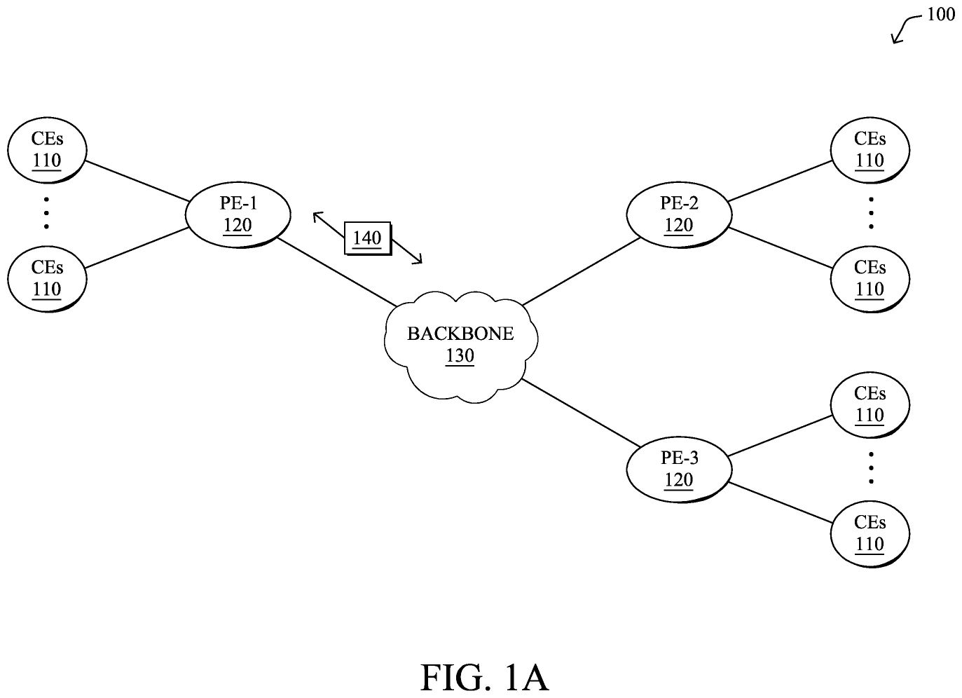

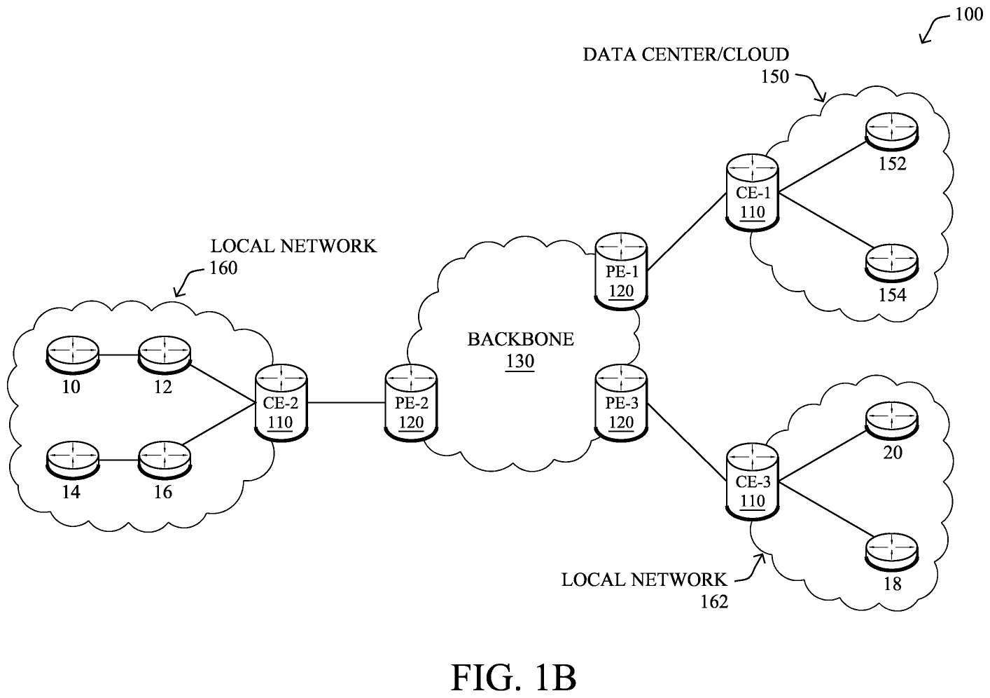

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

In various embodiments, network 100 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 160 may be an LLN in which CE-2 operates as a root node for nodes/devices 10-16 in the local mesh, in some embodiments.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QOS), security, network management, and traffic engineering extremely challenging, to mention a few.

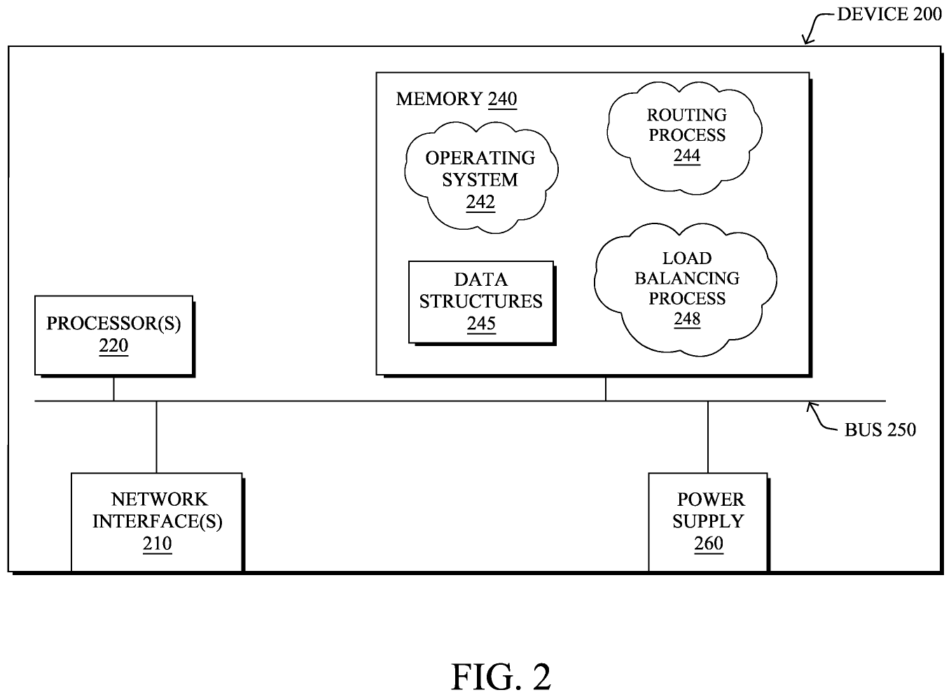

FIG. 2 is a schematic block diagram of an example node/device 200 that may be used with one or more embodiments described herein, e.g., as any of the computing devices shown in FIGS. 1A-1B, particularly the PE routers 120, CE routers 110, nodes/device 10-20, servers 152-154 (e.g., a network controller located in a data center, etc.), any other computing device that supports the operations of network 100 (e.g., switches, etc.), or any of the other devices referenced below. The device 200 may also be any other suitable type of device depending upon the type of network architecture in place, such as IoT nodes, IIOT node, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.). portions of which are typically resident in memory 240 and executed by the processor(s), functionally organizes the node by, inter alia, invoking network operations in support of software processors and/or services executing on the device. These software processors and/or services may comprise routing process 244 (e.g., routing services) and illustratively, a load balancing process 248 (e.g., a gateway-agnostic load balancing for Internet of Things remote access process), as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

Routing process/services 244 include computer executable instructions executed by processor 220 to perform functions provided by one or more routing protocols, such as the Interior Gateway Protocol (IGP) (e.g., Open Shortest Path First, “OSPF,” and Intermediate-System-to-Intermediate-System, “IS-IS”), the Border Gateway Protocol (BGP), etc., as will be understood by those skilled in the art. These functions may be configured to manage a forwarding information database including, e.g., data used to make forwarding decisions. In particular, changes in the network topology may be communicated among routers 200 using routing protocols, such as the conventional OSPF and IS-IS link-state protocols (e.g., to “converge” to an identical view of the network topology).

Load balancing process 248 includes computer executable instructions that, when executed by processor(s) 220, cause device 200 to perform gateway agnostic load balancing functions as part of a load balancing infrastructure within the network, as described herein. In general, load balancing attempts to distribute network traffic equally across a pool of resources (e.g., gateways, devices, etc.) associated with a network. For example, in one embodiment, the load balancing infrastructure (e.g., the gateway agnostic load balancing infrastructure) of the network may be operable to detect network traffic patterns, resources consumed by various components of the network in handling the network traffic, etc. However, load balancing, particularly load balancing while providing secure remote access to IoT assets and devices, in the context of computer networking typically presents a number of challenges and is currently not employed in the case of IoT remote access.

In various embodiments, load balancing process 248 may utilize machine learning techniques, to perform load balancing (e.g., gateway agnostic load balancing for IoT remote access) in the network. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

Computational entities that rely on one or more machine learning techniques to perform a task for which they have not been explicitly programmed to perform are typically referred to as learning machines. In particular, learning machines are capable of adjusting their behavior to their environment. For example, a learning machine may dynamically make future predictions based on current or prior network measurements, may make control decisions based on the effects of prior control commands, etc.

For purposes of load balancing for IoT remote access in a network, a learning machine may construct a model of normal network behavior, to detect data points that deviate from this model. For example, a given model (e.g., a supervised, un-supervised, or semi-supervised model) may be used to generate and report network traffic scores to another device. Example machine learning techniques that may be used to construct and analyze such a model may include, but are not limited to, nearest neighbor (NN) techniques (e.g., k-NN models, replicator NN models, etc.), statistical techniques (e.g., Bayesian networks, etc.), clustering techniques (e.g., k-means, etc.), neural networks (e.g., reservoir networks, artificial neural networks, etc.), support vector machines (SVMs), or the like.

One class of machine learning techniques that is of particular use in the context of load balancing for IoT remote access is clustering. Generally speaking, clustering is a family of techniques that seek to group data according to some typically predefined notion of similarity. For instance, clustering is a very popular technique used in recommender systems for grouping objects that are similar in terms of people's taste (e.g., because you watched X, you may be interested in Y, etc.). Typical clustering algorithms are k-means, density based spatial clustering of applications with noise (DBSCAN) and mean-shift, where a distance to a cluster is computed with the hope of reflecting a degree of anomaly (e.g., using a Euclidian distance and a cluster based local outlier factor that takes into account the cluster density).

Replicator techniques may also be used for purposes of load balancing for IoT remote access. Such techniques generally attempt to replicate an input in an unsupervised manner by projecting the data into a smaller space (e.g., compressing the space, thus performing some dimensionality reduction) and then reconstructing the original input, with the objective of keeping the “normal” pattern in the low dimensional space. Example techniques that fall into this category include principal component analysis (PCA) (e.g., for linear models), multi-layer perceptron (MLP) ANNs (e.g., for non-linear models), and replicating reservoir networks (e.g., for non-linear models, typically for time series).

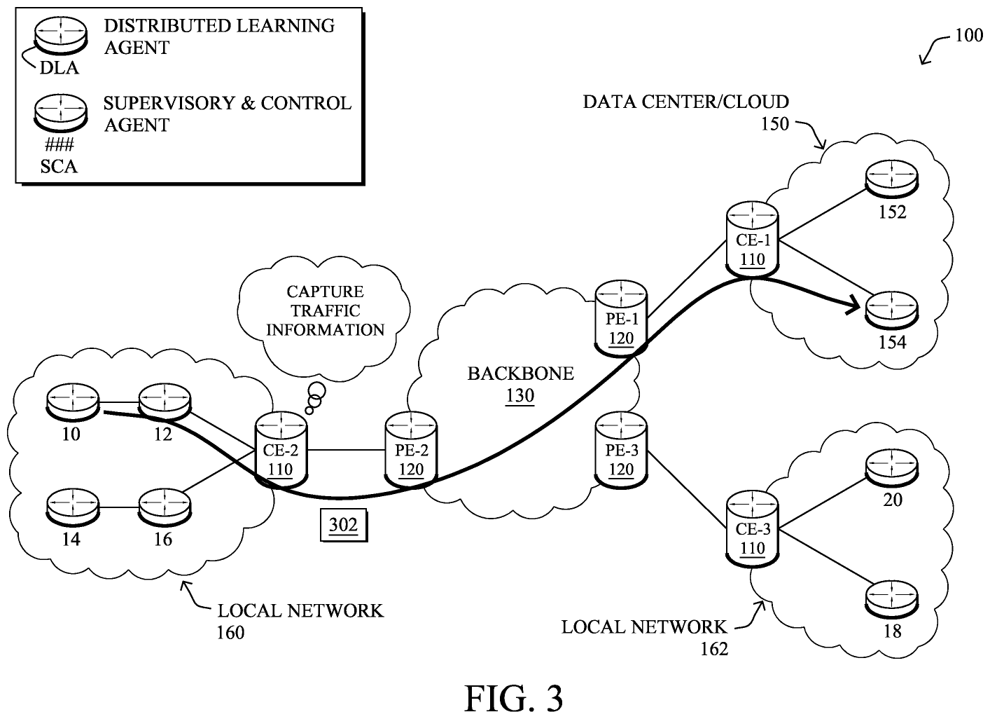

An example self learning network (SLN) infrastructure that may be used to detect network traffic for purposes of load balancing for IoT remote access is shown in FIG. 3. according to various embodiments. Generally, network devices may be configured to operate as part of an SLN infrastructure to detect, analyze, and/or mitigate instances where certain devices (or gateways) are over-burdened with network traffic while other devices (or gateways) are under-burdened with network traffic (e.g., by executing load balancing process 248). Such an infrastructure may include certain network devices acting as distributed learning agents (DLAs) and one or more supervisory/centralized devices acting as a supervisory and control agent (SCA). A DLA may be operable to monitor network conditions (e.g., router states, traffic flows, etc.), perform network traffic analysis on the monitored data using one or more machine learning models, report the network traffic analysis to the SCA, and/or perform load balancing (e.g., gateway agnostic load balncing). Similarly, an SCA may be operable to coordinate the deployment and configuration of the DLAs (e.g., by downloading software upgrades to a DLA, etc.), receive information from the DLAs, provide information regarding a network traffic state of multiple device and/or gateways in the network (e.g., by providing a visualization on a user interface, etc.), and/or analyze data regarding network traffic state for the devices and/or gateways using more CPU intensive machine learning processes.

As shown in FIG. 3, routers CE-2 and CE-3 may be configured as DLAs and server 152 may be configured as an SCA, in one implementation. In such a case, routers CE-2 and CE-3 may monitor traffic flows, router states (e.g., queues, routing tables, etc.), or any other conditions that may be indicative of a need for load balancing in network 100. As would be appreciated, any number of different types of network devices may be configured as a DLA (e.g., routers, switches, servers, blades, etc.) or as an SCA.

Assume, for purposes of illustration, that CE-2 acts as a DLA that monitors traffic flows associated with the devices of local network 160 (e.g., by comparing the monitored conditions to one or more machine-learning models). For example, assume that device/node 10 sends a particular traffic flow 302 to server 154 (e.g., an application server, etc.). In such a case, router CE-2 may monitor the packets of traffic flow 302 and, based on its local network traffic detection mechanism, determine that traffic flow 302 could benefit from being load balanced.

In some cases, traffic 302 may be associated with a particular application supported by network 100. Such applications may include, but are not limited to, automation applications, control applications, voice applications, video applications, alert/notification applications (e.g., monitoring applications), communication applications, and the like. For example, traffic 302 may be email traffic, HTTP traffic, traffic associated with an enterprise resource planning (ERP) application, IoT traffic, IIoT traffic, etc.

As noted above, some approaches rely on various software solutions to provide secure remote access to IoT assets and devices. Notably, these devices must be accessible via network gateways in order to facilitate communication. Each mechanism for connecting to a device (such as SSH, RDP, VNC, etc.) can be referred to as an access method. Unfortunately, many remote access technologies provide limited options for configuring which gateway an access method should connect through. In most cases, the gateway is statically assigned during initial configuration. For example, Cisco® Secure Equipment Access (SEA) requires each device, and consequently each access method, to be configured behind a single gateway. While these static frameworks are widely adopted, they are also rigid and inflexible in response to varied network demands and circumstances such as the following:
Unreliable Networks: A single gateway failure renders all subtended devices inaccessible, even if those devices are accessible via other existing gateways. For customers with many devices in a network, this single point of failure risks crippling loss of connectivity.
Inefficient Networks: Static configuration is also susceptible to inefficiencies in remote access throughput. If a large number of sessions are active simultaneously, gateways with many associated devices may be strained with an overwhelming amount of network traffic, while other gateways with few associated devices are left underutilized.

One solution to address these shortcomings is load balancing, a strategy that describes efficient distribution of network traffic across a pre-defined set of servers. However, load balancing has never been applied to IoT remote access. Presumably, load balancing session network traffic across many gateways would protect against both throughput inefficiency and gateway failure.

That said, standard load balancing approaches seen in the market today typically rely on a pre-defined set of entities to balance across, and these pre-defined entities (in this case gateways) must have identical functionality, such that any possible network load can be sent to any of the gateways. Applied to remote access, this identical functionality requirement is not guaranteed because not all gateways can access all devices at all times. For instance, gateways may have overlapping groups of wireless devices, but different groups of devices physically connected via serial ports, resulting in varied sets of accessible subtended devices, and thus varied remote access capabilities. These capabilities may also change throughout the life of a network. Therefore, in large scale deployment scenarios common to the IoT, asking end users to repeatedly and manually track which gateways can access which devices is infeasible.

However, removing pre-configuration introduces a new corner case. In remote access scenarios, devices are identified by IP address or DNS name. Without pre-configuring each device behind a gateway, it is possible that two devices will have identical IP addresses or DNS names, rendering the two entities indistinguishable to the load balancer. Thus, any application of configuration-free load balancing to IoT remote access must introduce new mechanisms for differentiating between remote devices.

In summary, the problem faced by IoT remote access software is:
These technologies may need load balancing to improve efficiency and reliability;
Load balancing is generally not applied to gateways managing IoT remote access; and
Standard load balancing approaches generally do not account for varied gateway functionality, rendering pre-configuration of load balancing groups an infeasible or impossible task.

### Gateway Agnostic Load Balancing

The techniques herein provide a load balancing mechanism for remote access to IoT and IIoT devices that is gateway agnostic and dynamic. In contrast to previous approaches, embodiments herein contemplate a system that bases decisions on dynamic factors, such as whether any given gateway can actually reach a target IoT device at any given time. In addition, no pre-configuration is needed in accordance with the present disclosure as it is gateway agnostic. Further, embodiments herein provide a solution that introduces additional validation checks to differentiate between devices with similar or identical identifying information.

Specifically, according to one or more embodiments of the disclosure as described in detail below, a process discovers a plurality of remote access enabled gateways with access to a specific subtended device in a computer network. The process also determines connective functionality of the plurality of remote access enabled gateways to the specific subtended device and a level of utilization of the plurality of remote access enabled gateways. The process may then select a specific gateway of the plurality of remote access enabled gateways through which to open an access session to the specific subtended device based on the specific gateway having sufficient connective functionality and further based on the level of utilization of the plurality of remote access enabled gateways.

Illustratively, the techniques described herein may be performed by hardware, software, and/or firmware, such as in accordance with the load balancing process 248, which may include computer executable instructions executed by the processor 220 (or independent processor of interfaces 210) to perform functions relating to the techniques described herein, e.g., in conjunction with routing process 244.

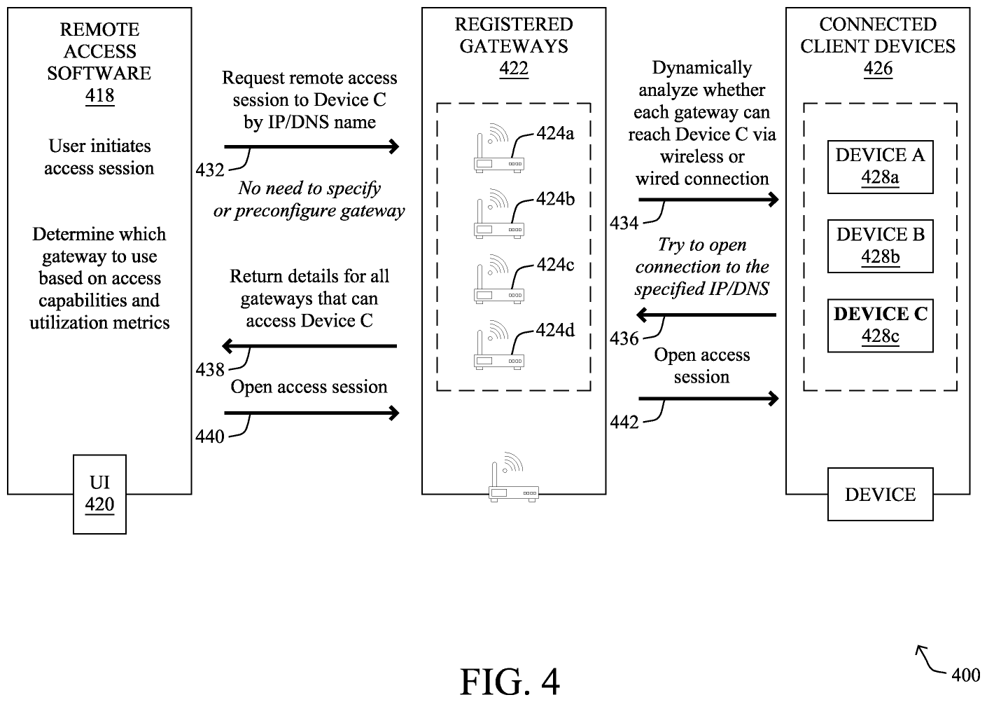

Operationally, FIG. 4 illustrates a system for gateway agnostic load balancing in a network 400 in accordance with one or more embodiments described herein. As shown in FIG. 4, the network 400 includes remote access software 418, e.g., instructions that are executable by a hardware processing resource to provide remote access functionality for the network 400. The remote access software 418 can further include instructions that generate a visualization on a user interface 420 (or “UI 420” for brevity). In various embodiments, the remote access software 418 allows a user to initiate an access session and, once the user has initiated the access session, determine which gateway to use based, at least in part, on access capabilities and/or utilization metrics, as described in more detail, herein.

As shown in FIG. 4, the network 400 includes a plurality of registered gateways 422, which include individual gateways 424a, 424b, 424c, 424d, etc. (referred to herein collectively as the “gateways 424”). In general, a “gateway” refers to the infrastructure required to provide radio coverage and packet forwarding for the client devices 426, as well as internet protocol backhaul to the network server (not explicitly shown in FIG. 4 so as to not obfuscate the layout of the drawings).

In various embodiments, the network 400 further includes a plurality of connected client devices 426, which include individual client devices such as device A 428a, device B 428b, and device C 428c, etc. (referred to herein collectively as the “client devices 428”). The client devices 428 can be IoT devices, IIOT devices, or various combinations of both IoT and IIOT devices.

In order to elucidate aspects of the disclosure, the following non-limiting example is provided. At operation 432, the remote access software 418 requests a remote access session via the plurality of registered gateways 422 to Device C 428c, which is specified by an internet protocol (IP) address and domain name system (DNS) in response to a user initiating the access session. In some embodiments, the user can initiate the access session via an input to the UI 420. It is noted that, in contrast to previous approaches, operation 432 may be performed without the need to specify and/or preconfigure the gateway.

At operation 434, each of the individual gateways 424 are dynamically analyzed to determine whether any of the gateways 424 are able to reach Device C 428c with either a wired or wireless connection.

If any of the gateways 424 are able to reach Device C 428c with a wired or wireless connection, at operation 436, an attempt is made to open the connection to Device C 428c to the IP/DNS specified at operation 432. Next, at operation 438, details for all the gateways 424 that are able to, in this non-limiting example, access Device C 428c are returned to the remote access software 418 where it is determined which gateway 424 to use based on the access capabilities and/or utilization metrics associated with the gateways 424.

Then, in operations 440 and 442, the remote access software 418 opens the access session via a specifically selected registered gateway 422 to the targeted, connected client device 426. In this non-limiting example, the access session is directed to Device C 428c and, accordingly, the registered gateways 422 (i.e., a selected gateway 424) open the access session at operation 442 with Device C 428c.

It is noted that, through utilization of the techniques described herein, a flexible framework for configuring gateway load balancing groups in real time while enabling IoT secure remote access software to dynamically select a gateway through which remote access sessions are initiated is provided. Accordingly, aspects of the disclosure provide a new type of gateway agnostic load balancer that requires no pre-configuration nor any mandate as to homogenous gateway functionality. Furthermore, the load balancing described herein allows for not only distribution of traffic based on central processing unit (CPU) or network resources, but also based on which devices are reachable.

In various embodiments, the gateway agnostic load balancing techniques of the present disclosure provide device 428 access methods that do not store any static information for gateways 424. Accordingly, users will not need to pre-configure any set of gateways 424, and users will not need to worry about which gateways 424 can connect to which devices 428 at which times. Instead, the remote access software 418 automatically discerns gateway 424 information at run-time. When a new access session is initiated, for example, at operation 432, gateway agnostic load balancing is performed by first searching for all remote access enabled gateways 424 which have access to the specific subtended device (e.g., the Device C 428c in the non-limiting example above) by attempting to initiate a connection to the specified device IP address and/or DNS name, and then open the session through the least utilized gateway that has the necessary connective functionality to support the access session. In some embodiments, this intelligence will occur not only in response to attempting to open remote access sessions, but the remote access software 418 may also continuously load balance the session throughout its life cycle. At certain intervals, the process will repeat, searching for candidate gateways 424 and redirecting session network traffic as needed.

Notably, to address the corner case of identically identified remote devices, gateway agnostic load balancing in accordance with the disclosure may allow users to specify additional device details such as a serial number, access protocol, or other identifying information that can enable the remote access software 418 to differentiate between devices with the same IP address or DNS name to provide gateway agnostic load balancing. Equipped with this added validation, the components of the network 400 can avoid opening remote access sessions to incorrect devices 428 and may instead return an error code in these edge cases.

As discussed above, in various embodiments, the gateway agnostic load balancing described herein provides an improvement not only to IoT/IIoT remote access, but also provides an improvement to a computing system and/or network in which embodiments of the disclosure are deployed in at least the following ways: (1) the efficiency of the computing system and/or network is improved at least because the gateway agnostic load balancing is able to account for situations where gateways are overloaded with excessive session network traffic and can redirect such network traffic as needed to maintain multiple smoothly running sessions simultaneously; (2) the reliability of the computing system and/or network is improved at least because instead of statically attempting access through one gateway (or even a set of gateways) to a specific device and/or access method, the gateway agnostic load balancing is able to dynamically search for candidate gateways, thereby diminishing the consequences of one or more gateway failures; and (3) the usability of the computing system and/or network is improved at least because the gateway agnostic load balancing may abstract and automate configurations, thereby allowing users to add new gateways to their networks without needing to manually associate that gateway with potentially large numbers of existing devices.

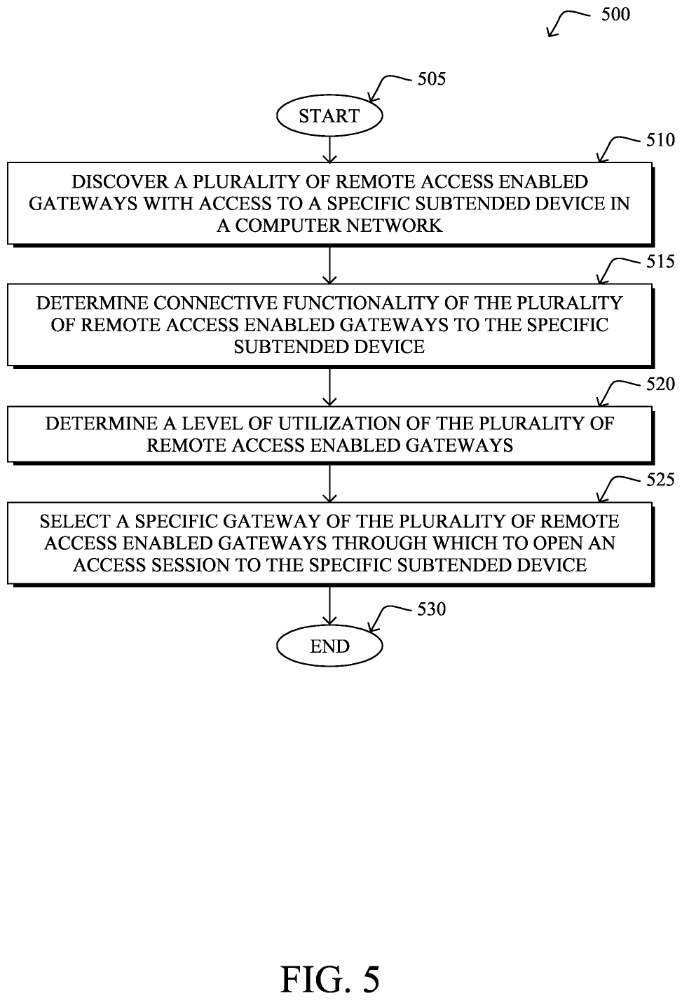

FIG. 5 illustrates an example simplified procedure for gateway agnostic load balancing in a network in accordance with one or more embodiments described herein. For example, a non-generic, specifically configured device (e.g., device 200 or apparatus) may perform procedure 500 by executing stored instructions (e.g., process 248 or method). The procedure 500 may start at step 505, and continues to step 510, where, as described in greater detail above, the process discovers a plurality of remote access enabled gateways with access to a specific subtended device in a computer network. As discussed above, the specific subtended device can be an Internet of Things device or an Industrial Internet of Things device.

At step 515, as detailed above, the process determines connective functionality of the plurality of remote access enabled gateways to the specific subtended device. In various embodiments, sufficient connective functionality (e.g., of the plurality of remote access enabled gateways to the specific subtended device) is based on adequate and available central processing unit (CPU) and memory resources.

At step 520, as detailed above, the process determines a level of utilization of the plurality of remote access enabled gateways. In some embodiments, the process selects the specific gateway as a least utilized gateway of the plurality of remote access enabled gateways, based, at least in part, on the level of utilization of the plurality of remote access enabled gateways.

At step 525, the process selects a specific gateway of the plurality of remote access enabled gateways through which to open an access session to the specific subtended device based on the specific gateway having sufficient connective functionality and further based on the level of utilization of the plurality of remote access enabled gateways. In some embodiments, the process further includes causing opening of the access session.

In various embodiments, the process selects the specific gateway in response to learning of a new access session being initiated to the specific subtended device. Embodiments are not so limited, however, and in some embodiments, the process selects the specific gateway during operation of the access session and based on updates to the connective functionality and the level of utilization of the plurality of remote access enabled gateways.

In various embodiments, the process differentiates between devices with indistinguishable identifying information based on one or more additional criteria. Non-limiting examples of such criteria can be selected from a group consisting of a serial number, an access protocol, and/or a device behavior, among others.

In various embodiments, discovering the plurality of remote access enabled gateways, determining the connective functionality determining the level of utilization, and selecting the specific gateway are performed in real-time.

As discussed above, the computer network can be an an Internet of Things (IoT) network. In such embodiments, the IoT network can be an Industrial Internet of Things IIOT) network.

Procedure 500 then ends at step 530.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide a load balancing mechanism for remote access to IoT devices and IIOT that is gateway agnostic and dynamic. For example, as discussed above, embodiments herein provide a system that bases decisions on dynamic factors, such as whether any given gateway can actually reach a target IoT device at any given time. In addition, no pre-configuration is needed in accordance with the present disclosure as it is gateway agnostic. Further, embodiments herein provide a solution that introduces additional validation checks to differentiate between devices with similar or identical identifying information.

While there have been shown and described illustrative embodiments that provide for gateway agnostic load balancing for Internet of Things remote access, it is to be understood that various other adaptations and modifications may be made within the spirit and scope of the embodiments herein. For example, while certain embodiments are described herein with respect to using certain criteria for purposes of gateway agnostic load balancing, the criteria and/or methodologies are not limited as such and may be used for other functions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having computer-executable program instructions stored thereon that execute on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
discovering, by a process, a plurality of remote access enabled gateways with access to a specific subtended device in a computer network;
determining, by the process, connective functionality of the plurality of remote access enabled gateways to the specific subtended device;
determining, by the process, a level of utilization of the plurality of remote access enabled gateways; and
selecting, by the process, a specific gateway of the plurality of remote access enabled gateways through which to open an access session to the specific subtended device based on the specific gateway having sufficient connective functionality and further based on the level of utilization of the plurality of remote access enabled gateways.

2. The method as in claim 1, further comprising:
causing opening of the access session.

3. The method as in claim 1, wherein selecting is in response to learning of a new access session being initiated to the specific subtended device.

4. The method as in claim 1, wherein selecting is performed during operation of the access session and based on updates to the connective functionality and the level of utilization of the plurality of remote access enabled gateways.

5. The method as in claim 1, wherein sufficient connective functionality is based on adequate and available CPU and memory resources.

6. The method as in claim 1, further comprising:
differentiating between devices with indistinguishable identifying information based on one or more additional criteria.

7. The method as in claim 6, wherein the one or more additional criteria are selected from a group consisting of: serial number; access protocol; and device behavior.

8. The method as in claim 1, wherein selecting based on the level of utilization comprises:
selecting the specific gateway as a least utilized gateway of the plurality of remote access enabled gateways.

9. The method as in claim 1, wherein discovering the plurality of remote access enabled gateways, determining the connective functionality determining the level of utilization, and selecting the specific gateway are performed in real-time.

10. The method as in claim 1, wherein the computer network comprises an Internet of Things network.

11. The method as in claim 1, wherein the specific subtended device comprises an Internet of Things device.

12. The method as in claim 10, wherein the Internet of Things network comprises an Industrial Internet of Things network.

13. A tangible, non-transitory, computer-readable medium having computer-executable instructions stored thereon that, when executed by a processor on a computer, cause the computer to perform a method comprising:
discovering a plurality of remote access enabled gateways with access to a specific subtended device in a computer network;
determining connective functionality of the plurality of remote access enabled gateways to the specific subtended device;
determining a level of utilization of the plurality of remote access enabled gateways; and
selecting a specific gateway of the plurality of remote access enabled gateways through which to open an access session to the specific subtended device based on the specific gateway having sufficient connective functionality and further based on the level of utilization of the plurality of remote access enabled gateways.

14. The tangible, non-transitory, computer-readable medium as in claim 13, wherein the method further comprises:
causing opening of the access session.

15. The tangible, non-transitory, computer-readable medium as in claim 13, wherein selecting is in response to learning of a new access session being initiated to the specific subtended device.

16. The tangible, non-transitory, computer-readable medium as in claim 13, wherein selecting is performed during operation of the access session and based on updates to the connective functionality and the level of utilization of the plurality of remote access enabled gateways.

17. The tangible, non-transitory, computer-readable medium as in claim 13, wherein sufficient connective functionality is based on adequate and available CPU and memory resources.

18. The tangible, non-transitory, computer-readable medium as in claim 13, wherein the method further comprises:
differentiating between devices with indistinguishable identifying information based on one or more additional criteria.

19. An apparatus, comprising:
one or more network interfaces to communicate with a network;
a processor coupled to the one or more network interfaces and configured to execute one or more processes; and
a memory configured to store a process that is executable by the processor, the process, when executed, configured to:
discover a plurality of remote access enabled gateways with access to a specific subtended device in a computer network;
determine connective functionality of the plurality of remote access enabled gateways to the specific subtended device;
determine a level of utilization of the plurality of remote access enabled gateways; and
select a specific gateway of the plurality of remote access enabled gateways through which to open an access session to the specific subtended device based on the specific gateway having sufficient connective functionality and further based on the level of utilization of the plurality of remote access enabled gateways.

20. The apparatus as in claim 19, wherein the process, when executed, is further configured to:
cause opening of the access session.
